(19) United States
(12) Patent Application Publication
(10) Pub. No.: US 2017/0287597 A1
(43) Pub. Date: Oct. 5, 2017

(54) ELASTOMERIC AND FLEXIBLE CABLES

(71) Applicant: Minnesota Wire, St. Paul, MN (US)

(72) Inventors: Paul J. Wagner, Eagan, MN (US); Kevin Voigt, St. Paul, MN (US); Scott Fitzharris, St. Paul, MN (US); Thomas Welty, St. Paul, MN (US); Mario Dominguez, St. Paul, MN (US); Aaron Stevens, Apple Valley, MN (US)

(21) Appl. No.: 15/478,787

(22) Filed: Apr. 4, 2017

Related U.S. Application Data
(60) Provisional application No. 62/317,901, filed on Apr. 4, 2016.

(51) Int. Cl. H01B 11/18; H01B 7/17; B29C 47/00; H01B 13/08; H01B 13/02; G02B 6/44; H01B 7/04; H01B 13/14

(52) U.S. Cl. CPC H01B 11/1895; H01B 7/04; H01B 7/17; H01B 13/14; H01B 13/08; H01B 13/02; H01B 11/1878; G02B 6/4434; G02B 6/4489; G02B 6/443; B29C 47/0061; B29K 2021/003

(57) ABSTRACT

Systems and methods presented herein provide for elastomeric and flexible cables. In one embodiment, an elastomeric cable comprises an elastomeric core (e.g., a stretchable polymer) and at least one cabling component wound about the elastomeric core along a length of the elastomeric core.

### CROSS REFERENCE TO RELATED APPLICATIONS

This patent application claims priority to, and thus the benefit of an earlier filing date from, U.S. Provisional Patent Application No. 62/317,901 (filed Apr. 4, 2016), the entire contents of which are hereby incorporated by reference.

### BACKGROUND

Wire and cable are ubiquitous. They exist in buildings, vehicles, electronic devices, appliances, utilities, agriculture, construction, etc. While in many instances flexible, wire and cable generally do not stretch. And, continuous flexing of the wire eventually fractures the wire and reduces its conductivity. For example, in the wearable electronics industry, cable manufacturers configure malleable cables using stainless steel wire or other rigid materials laid alongside insulated conductors. The combination is then encased in a heat shrink material. But, this generally results in a configuration that prevents the overall cable from being fully malleable and can result in the heat shrink material eventually wearing and fraying due to the ridge of the underlying wire.

### SUMMARY

Systems and methods presented herein provide for elastomeric and flexible cables. In one embodiment, an elastomeric cable comprises an elastomeric core (e.g., a stretchable polymer) and at least one cabling component wound about the elastomeric core along a length of the elastomeric core.

The various embodiments disclosed herein may be implemented in a variety of ways as a matter of design choice. For example, some embodiments herein are implemented in physical cables whereas other embodiments may include processes that are operable to implement and/or operate the cables.

### BRIEF DESCRIPTION OF THE DRAWINGS

FIG. 1 is a perspective view of an exemplary 8×4 elastomeric cable.

FIG. 2 is a perspective view of an exemplary elastomeric fiber optic cable.

FIG. 3 is a perspective view of an exemplary elastomeric ribbon cable.

FIG. 4 is a perspective view of an exemplary elastomeric cable with an orange peel textured elastomeric core.

FIG. 5 is a perspective view of an exemplary elastomeric cable comprising a single-serve/single-directional shielding.

FIG. 6 is a perspective view of an exemplary elastomeric cable comprising a double-serve shielding.

FIG. 7 is an end view of an exemplary elastomeric cable comprising braided, knitted, or woven conductors.

FIG. 8 is an end view of an exemplary elastomeric cable comprising an elliptical elastomeric core and braided conductors.

FIGS. 9 and 10 illustrate perspective views of exemplary elastomeric Ethernet cables.

FIGS. 11-14 illustrate elastomeric cables comprising braided/served conductors.

FIG. 15 is a flowchart of a method for making an elastomeric cable.

### DETAILED DESCRIPTION OF THE DRAWINGS

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention and are to be construed as being without limitation to such specifically recited examples and conditions. As a result, the invention is not limited to the specific embodiments or examples described below.

The various embodiments illustrate elastomeric/flexible cables and their various constructions. For example, the elastomeric cables disclosed herein generally have an elastomeric non-conductive core configured from a polymer. At least one cabling component, such as an optical fiber for data transmission, a metal conductor for data transmission, and/or a metal conductor for power, may be wound about the elastomeric core to form an elastomeric cable. The elastomeric core allows the cable to stretch and bend more easily while the cabling components provide the desired cable functionality (e.g., power, data, etc.).

The cabling components also act as a sort of “stay cord” for the cable. For example, the cabling component is wound about a length of the cable. So, the cable can stretch due to the elasticity of the elastomeric core. But, based on the winding of the cabling component, the overall cable will only be able to stretch so far because the cabling component compresses against the core as the cable is stretched. This compression tends to stiffen the elastomeric core and aids in preventing the cable from breaking.

In one embodiment, the cable may comprise a single serve shielding wrapped about the at least one cabling component. The cable may also include a second single serve shielding wrapped about the single serve shielding in an opposite fashion. The shielding(s) may be configured from nickel plated aramid, nickel plated cellulose, nickel plated carbon fiber, metal foil, or a combination thereof. The cable may also include a protective cover extruded about the cable or heat shrinked about the cable. The protective cover may comprise “wings” that are operable to sew the cable into clothing or other fabrics. For example, an extra wing of material of the protective cover running along the length of the cable may provide a region where a needle may be used to run thread through the wing along the length of the cable to anchor the cable into clothing fabric or other fabric.

The cabling component may be braided, knitted, or woven with Kevlar/Aramid braids about the elastomeric core. In one embodiment, the elastomeric core is treated with a solvent, or an additive is used during extrusion to produce an orange peel texturing or dimpling of the elastomeric core. This texturing allows the cabling component to slide more easily along the core when the cable is stretched or bent.

Some embodiments of the present invention are now described, by way of example only, and with reference to the accompanying drawings. The same reference number represents the same element or the same type of element on all drawings. For example, an elastomeric cable 100 disclosed herein may comprise optical fibers, conductors, shieldings, and/or protective covers. Thus, the elastomeric cable 100 as disclosed herein comprises an elastomeric core with various configurations of cabling components.

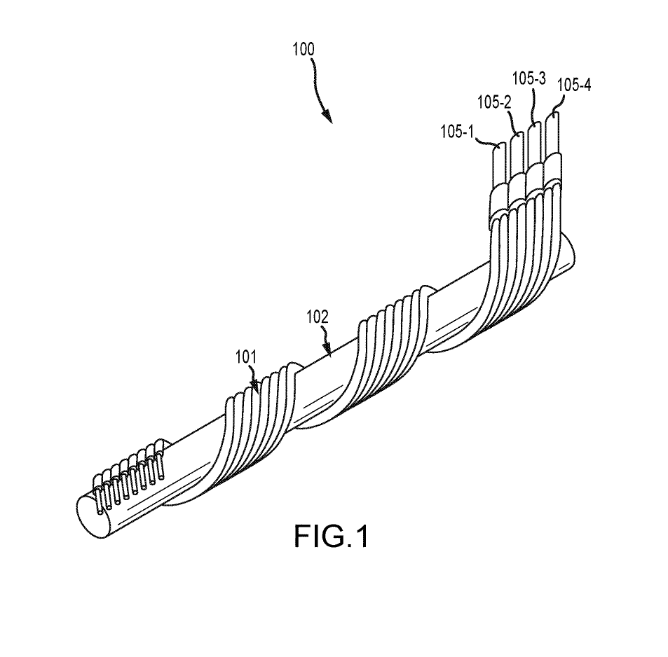

Turning now the illustrated embodiments, FIG. 1 is a perspective view of an exemplary 8×4 elastomeric cable 100. The cable 100 comprises an elastomeric core 102 and eight insulated conductors 101 wound about the elastomeric core 102. The eight insulated conductors 101 are terminated at one end of the cable into four conductor pins 105-1-105-4 that allow a user to select which of the conductors 101 are to be used for signaling and/or power. For example, if a user wishes to use two of the eight conductors 101 for power, the user may connect power to the terminated conductor pin 105-1, leaving the remaining six conductor pins 105-2-105-4 for signaling purposes (e.g., data transmission). By “ganging” conductors together in this manner allows the cable 100 to achieve a lower profile.

In this embodiment, the eight conductors 101 are wound about the elastomeric core 102 in a left hand wrap design. However, the invention is not intended be limited to any particular type of wrapping as a right hand wrap design may be implemented in the alternative. Such applies to the other embodiments shown and described hereinbelow.

The elastomeric core 102 may be configured from a polymer and extruded as a cylinder (or some other shape). The wrapping of the conductors 101 about the elastomeric core 102 allows the overall cable to stretch and bend without creating extensive wear on the conductors 101 themselves. For example, a single metal conductor that is continuously bent tends to fracture the metal and reduces its conductivity over time. The elastomeric core 102 reduces the bending of the conductors 101 when the overall cable 100 is bent. And, the relatively loose wrapping of the conductors 101 themselves allows the overall cable 100 to stretch via the elasticity of the elastomeric core 102.

And, the conductors 101 also act as a sort of “stay cord” that prevents the cable 100 from snapping when the cable 100 is stretched too far. For example, the elastomeric core 102 stretches to a certain length depending on the material extruded to form the elastomeric core 102 and/or the dimensions of the elastomeric core 102. As the cable 100 is stretched, the conductors 101 pinch the elastomeric core 102 to prevent further stretching, thereby preventing the cable 100 from breaking. Although illustrated with eight conductors 101 terminated into four pins 105, the invention is not intended be limited to such as the number of conductors and terminating pins 105 may be implemented as a matter of design choice. For example, the cable 100 could be configured two terminating pins 105 each having three conductors connected thereto, totaling 6 conductors. Such applies to the other embodiments shown and described hereinbelow.

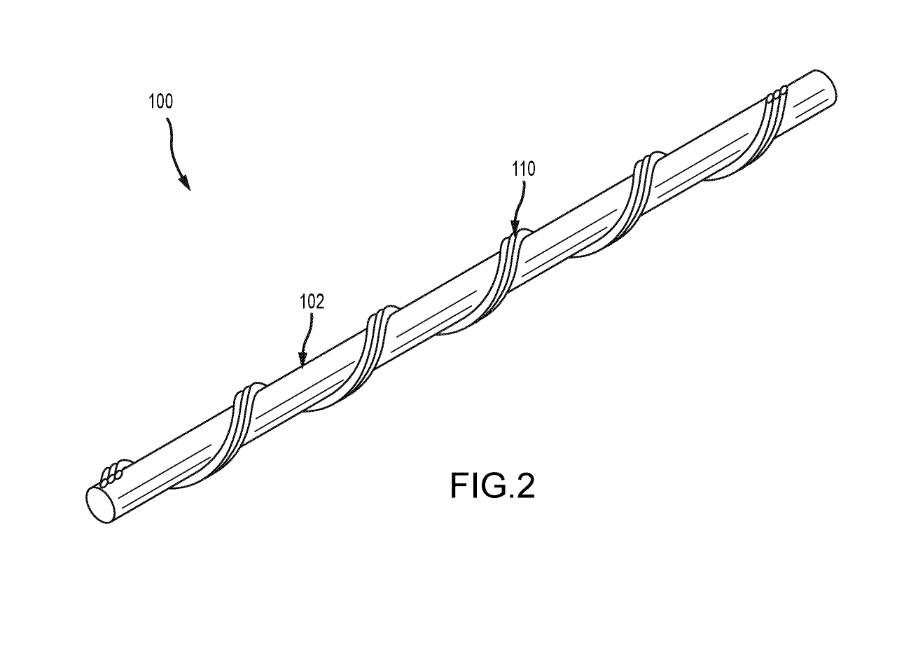

FIG. 2 is a perspective view of an exemplary elastomeric optical cable 100. In this embodiment, optical fibers 110 are wound about an elastomeric core 102. Modern optical fibers are now configured from more flexible materials such as plastic. This flexibility allows the optical fibers 110 to be wound about the elastomeric core 102 to provide an elastomeric optical cable. The optical fibers 110, themselves, also provide a sort of stay cord for the overall elastomeric optical cable 100 as described above.

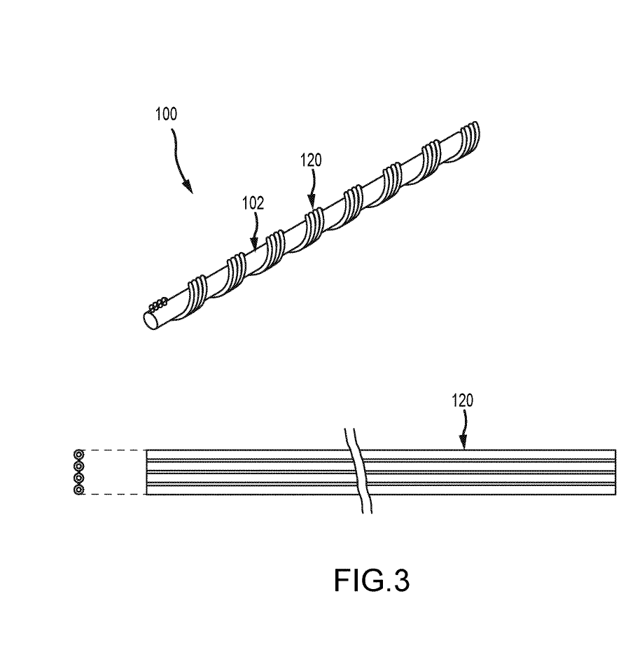

FIG. 3 is a perspective view of an exemplary elastomeric ribbon cable 100. In this embodiment, a traditional ribbon cable 120 is configured with a number of conductors that are separated and insulated by the ribbon material. The ribbon cable 120 is then wound about the elastomeric core 102 to provide the ribbon cable 120 with elastomeric properties as similarly described above.

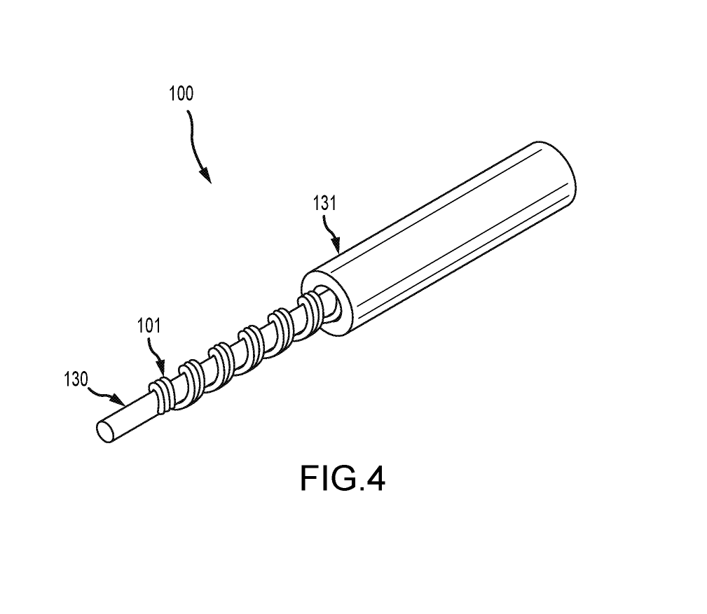

FIG. 4 is a perspective view of an exemplary elastomeric cable 100 with an orange peel textured elastomeric core 130. In this embodiment, the insulated conductors 101 are wound about the elastomeric core 130 as described above. The overall cable 100 is then insulated with an insulating material 131 or otherwise covered by a protective jacket.

The elastomeric core 130 is extruded as a cylinder using an elastomeric material (e.g., polyurethane). Generally, the elastomeric core 130 is extruded when the elastomeric material is relatively warm. After extrusion, the elastomeric core 130 is cooled in a solution that textures the elastomeric core 130 with an orange peel effect. For example, the elastomeric core 130 may be cooled with water comprising a solvent that dimples the elastomeric core 130. Alternatively or additionally, the texturing can be accomplished with a chemical additive to the polymer during extrusion.

This dimpling effect of the elastomeric core 130 allows the conductors 101 to slide along the length of the elastomeric core 130 as the cable is bent or stretched. Thus, the orange peel textured elastomeric core 130 provides further protection to the conductors 101 when the cable is stretched and/or bent. Again, this exemplary embodiment only shows conductors 101. However, other embodiments may include optical elements and/or other forms of conductors (e.g., elastomeric conductors embedded with carbon nanotubes for signaling purposes).

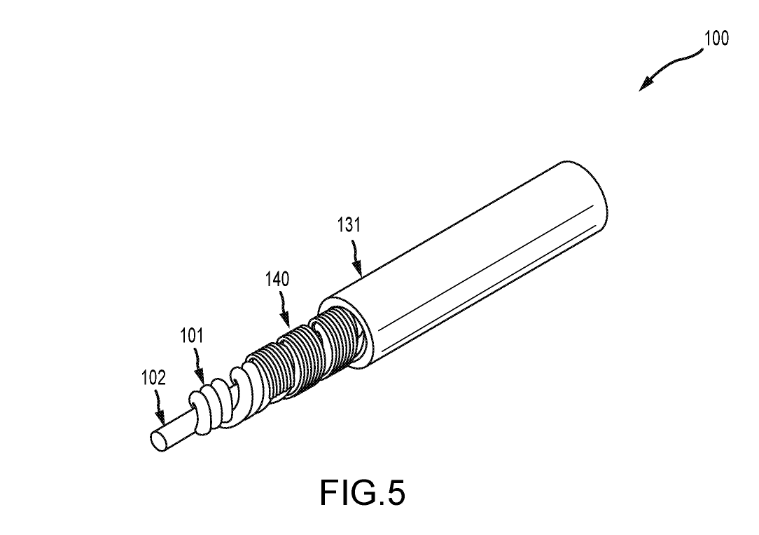

FIG. 5 is a perspective view of an exemplary elastomeric cable 100 comprising a single-serve/single-directional shielding 140. In this embodiment, the cable is configured as described hereinabove with the single serve shielding 140 wrapped about the conductors 101 to provide electromagnetic shielding for the conductors 101. The shielding 140 may be configured with a nickel plated aramid, cellulose, carbon fiber, combinations thereof, or the like. Alternatively, the shielding may be constructed from traditional materials such as aluminum foil, copper foil, or aluminum braiding, copper braiding, or combinations thereof.

The shielding 140 is loosely wrapped about the conductors so as to provide the conductors 101 with electromagnetic shielding as the cable stretches and bends. Afterwards, the cable may be insulated within insulating material 131 and/or a protective jacket (e.g., a shrink wrap) so as to protect the underlying components.

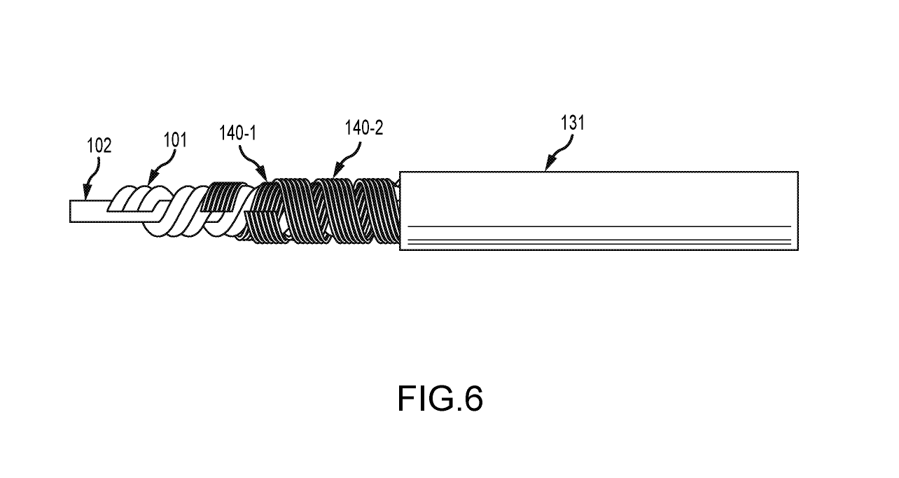

FIG. 6 is a side view of an exemplary elastomeric cable 100 comprising a double-serve/double-directional shielding. In this embodiment, a first shielding 140-1 is wrapped about the conductors 101 in a left hand wrap design. Then, a second shielding 140-2 is wrapped about the shielding 140-1 in an opposite right hand wrap design. This allows the cable to provide more shielding to the conductors 101 when the cable is stretched. For example, when the cable is stretched, gaps in the shielding 140-1 will become more prominent. These gaps are substantially covered by the shielding 140-2 as it is wrapped in the opposite direction of the shielding 140-1.

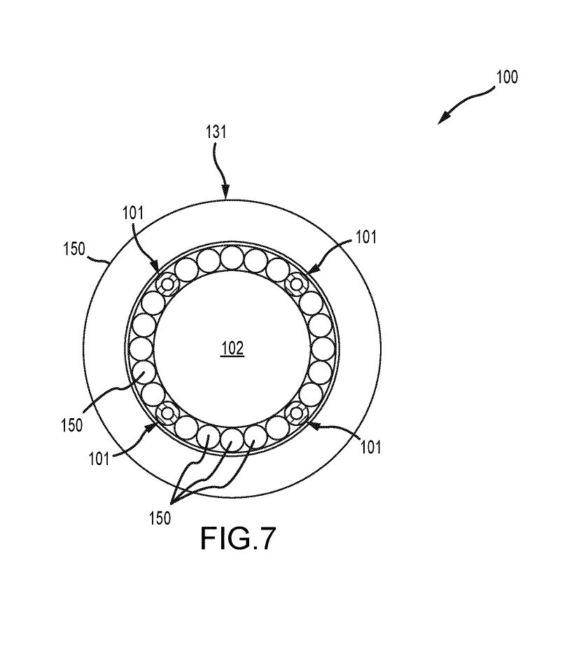

FIG. 7 is an end view of an exemplary elastomeric cable 100 comprising braided conductors. In this embodiment, four insulated conductors 101 are braided with 20 Kevlar strands 150 about the elastomeric core 102, with each conductor 101 being separated by five Kevlar strands 150. This braided cable 100 provides a certain level of comfort and flexibility when worn by a user of wearable electronics. For example, there is a movement in the electronics industry to provide users with electronics that may be fashioned with or to their clothing. Thus, flexible and durable (e.g., washable) cables need to be configured to connect to such devices. For example, batteries may need to be connected to washable electronic devices embedded in clothing via the cable 100. As the overall dimension of this cable 100 may be relatively small, the cable can be woven into clothing (e.g., as a “beading”) to connect devices. And, the braiding of the conductors 101 and the Kevlar strands 150 strengthen the overall cable to endure substantial wear and washings.

Although shown and described with respect to 20 Kevlar strands 150 braided with four insulated conductors 101, the invention is not intended be so limited. Rather, the number of Kevlar strands 150 and insulated conductors 101 may be braided in any number of ways using any number of strands 154 conductors 101 as a matter of design choice. Additionally, other materials may be used in place of the Kevlar strands 150.

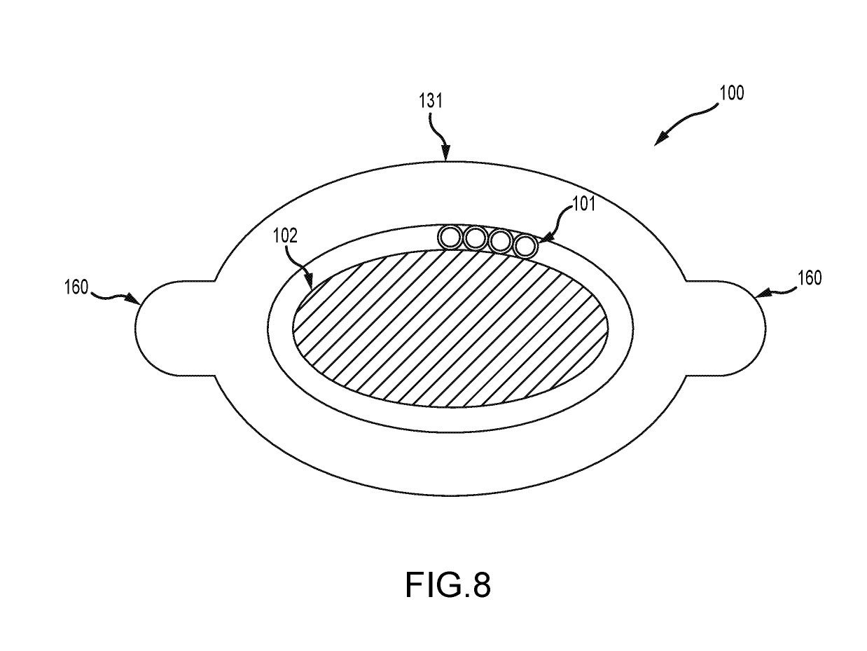

FIG. 8 is an end view of an exemplary elastomeric cable 100 comprising an elliptical elastomeric core 102 and braided conductors 101. The elliptical shape of the elastomeric core 102 is operable to provide a user of wearable electronics with more comfort. For example, assume that the cable 100 is embedded in a shoe. As the user presses against the lengthier portion of the ellipse of the elastomeric core 102, the elastomeric core 102 “squishes” and provides the user with more comfort as the user walks about.

In this embodiment, the cable is also configured with a protective covering (e.g., an insulator 131) that protects the underlying conductors 101. The protective covering includes wings 160 that allow for the cable 100 to the sewn into clothing. For example, a needle may pierce the wings 160 of the cable to sew the cable into the clothing. Again, any number of conductors 101 (and other braiding materials) may be braided about the elastomeric core 102.

The invention is not intended to be limited to any particular size or shape. The embodiments herein are merely intended to be exemplary and may be subject to a matter of design choice. For example, the elliptical dimensions of the elastomeric core 102 may be selected based on desired comfort, desired stretch, desired compression, and the like.

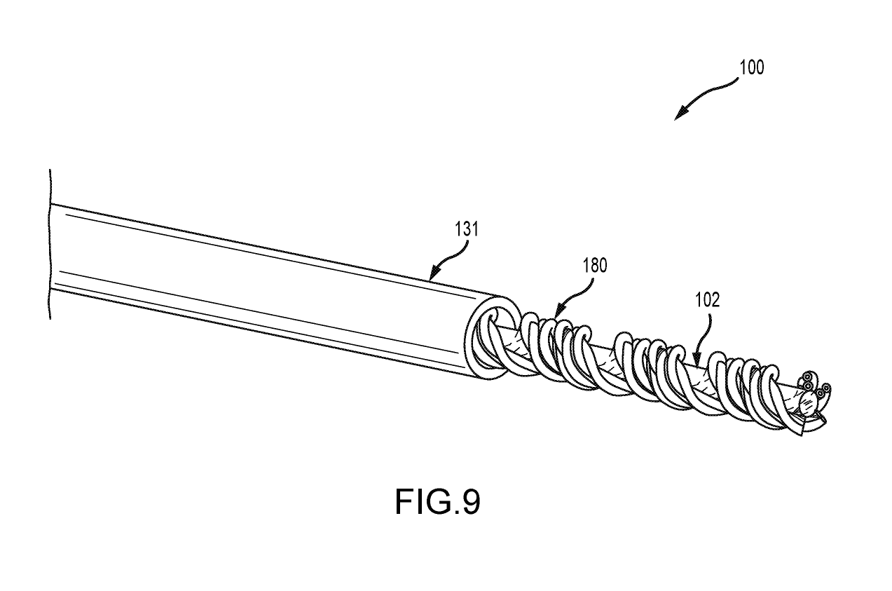

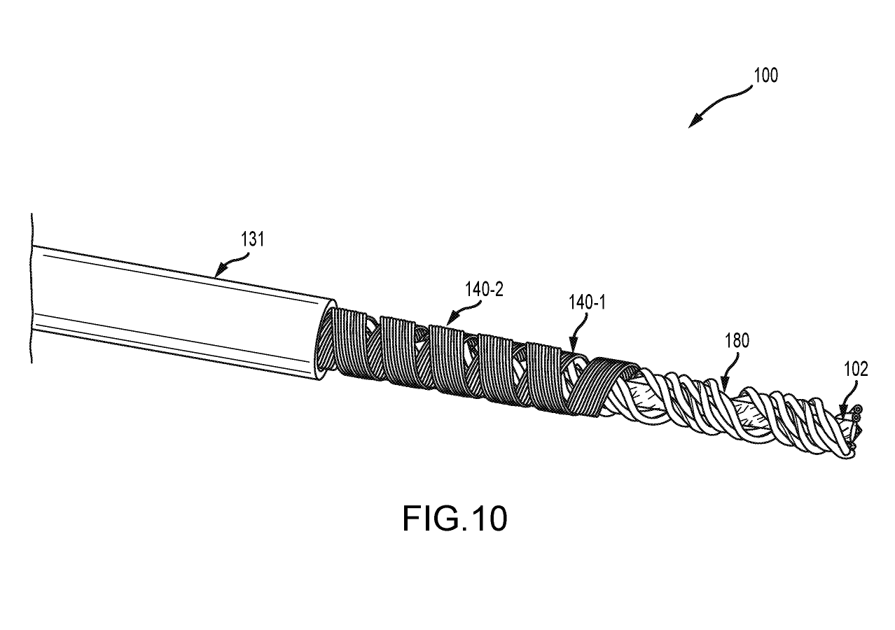

FIGS. 9 and 10 illustrate perspective views of exemplary elastomeric Ethernet cables 100. FIG. 9 illustrates elastomeric Ethernet cable 100 wound about an elastomeric core 102. The individual cables 180 of the Ethernet cable 100 may be twisted so as to reduce crosstalk. The Ethernet cable 100 is then wrapped about the elastomeric core 102 as described hereinabove so as to provide stretching and flexibility for the Ethernet cable. The Ethernet cable 100 may then be jacketed with a protective jacket 131. FIG. 10 illustrates the same cable 100 with a double serve shielding 140-1 and 140-2 as described hereinabove. The twisted pair lay length, cable lay, and lay direction may be selected as a matter of design choice for optimization. But, the ratio of the core 102 outer diameter and the spiral wrap of primaries 180 assist with the electrical and stretch performance. For example, a larger diameter core 102 may allow for a greater stretch length than a smaller diameter core. The outer jacket may be braided, extruded, or even omitted entirely. Accordingly, the invention is not intended be limited to the illustration herein. And, the individual cables 180 may represent twisted pairs used in a spiral core wrap.

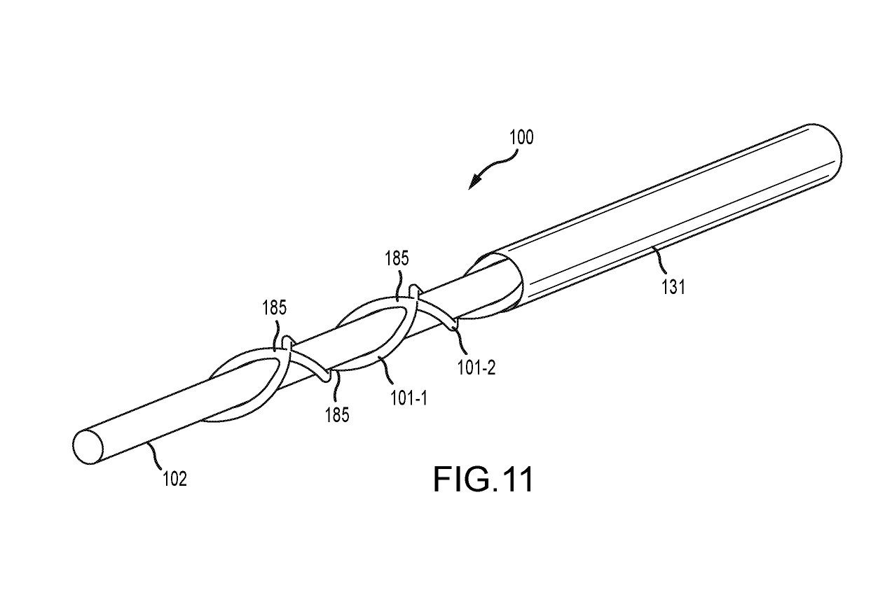

FIGS. 11-14 illustrate elastomeric cables 100 comprising braided conductors (e.g., served “bare”, meaning unjacketed, extruded, and/or coated) 101. For example, FIG. 11 illustrates an elastomeric cable 100 comprising an elastomeric core 102 as with the embodiments hereinabove. The elastomeric cable 100 also comprises twisted-pair conductors 101-1 and 101-2. That is, the conductors 101-1 comprise one twisted-pair of conductors whereas the conductors 101-2 comprising other twisted-pair of conductors. The twisted pairs 101-1 and 101-2 are braided about the length of the elastomeric core 102. This embodiment allows the cable 100 to stretch as described hereinabove. However, the twisted-pair conductors 101-1 and 101-2 provide additional stay cord functionality because the twisted-pair conductors 101-1 and 101-2 compress the elastomeric core 102 at alternating points 185 along the length of the cable 100. The cable 100, as with the embodiments above, may be covered with a protective material 131 (e.g., heat shrink, extruded material, etc.).

Some of the benefits for this embodiment include displacement crimping and piercing for robotic termination. That is, at a predetermined cable length, the cable 100 may be severed. This embodiment allows the resulting ends of the cable 100 to be robotically terminated with connectors as desired to provide the desired functionality for the cable. For example, when the cable 100 is severed, and RJ-11 connector can be robotically attached to the two twisted-pair conductors 101-1 and 101-2.

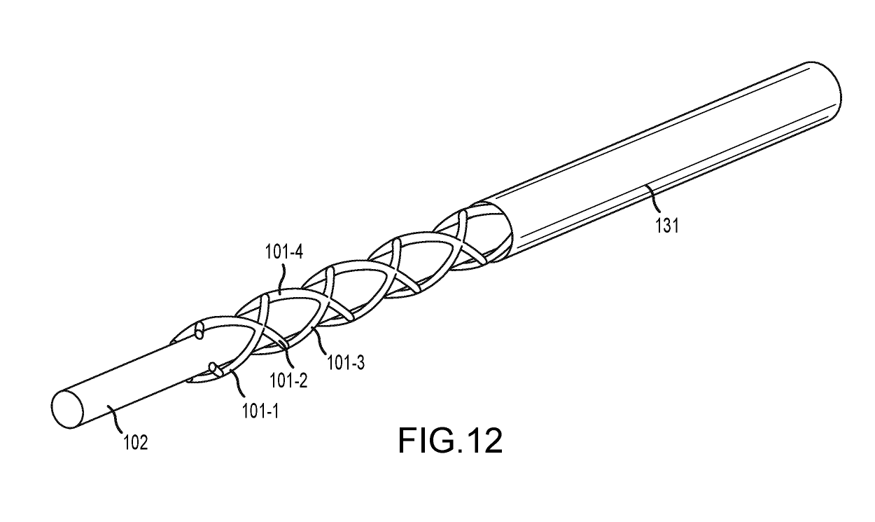

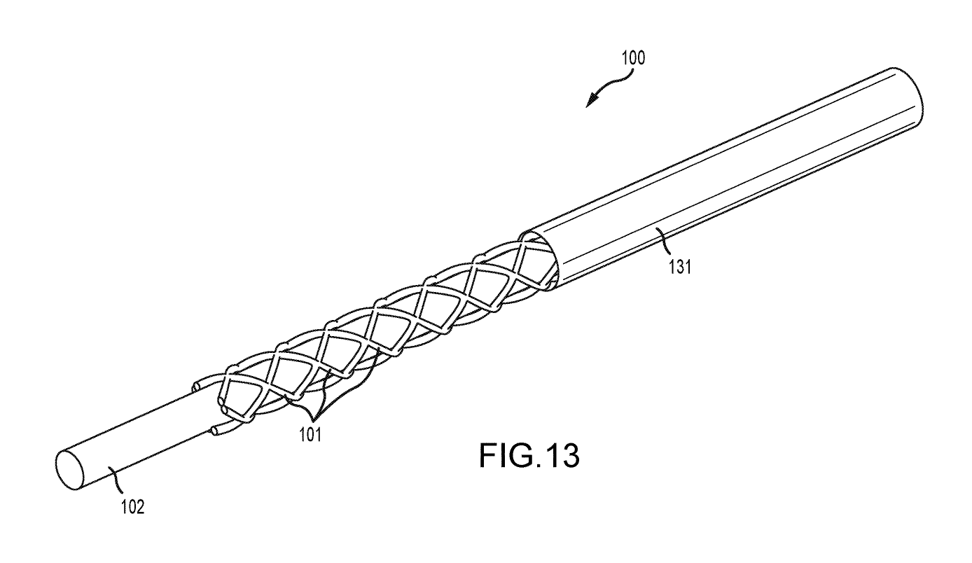

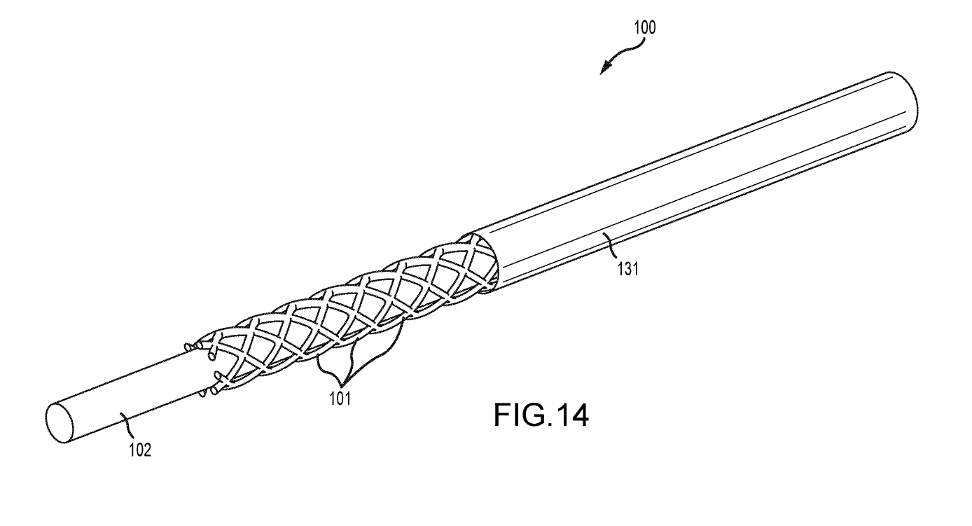

FIGS. 12-14 illustrate similar embodiments. For example, FIG. 12 illustrates an embodiment of the cable 100 with four twisted-pair conductors 101-1-101-4 braided about the length of the elastomeric core 102. FIG. 13 illustrates an embodiment of the cable 100 with six twisted-pair conductors 101 braided (or served) about the length of the elastomeric core 102. And, FIG. 14 illustrates an embodiment of the cable 100 with eight twisted-pair conductors 101 braided about the length of the elastomeric core 102. Alternatively, the conductors 101 themselves may be elastomeric. For example, U.S. Pat. No. 8,099,254 issued illustrates one type of elastomeric conductors that may be used in the exemplary embodiments of FIGS. 12-14. In such an embodiment, the conductors 101 may be bare such that the cable may be terminated with displacement crimpling. In either case, the conductors 101 may include a jacket extruded over the conductors 101. In other embodiments, the conductors 101 of the cables 100 of FIGS. 12-14 are configured from relatively fine stainless steel yarn, traditional metallic stranding (e.g., copper, tin, silver, etc.), and/or conductive carbon nanotubes.

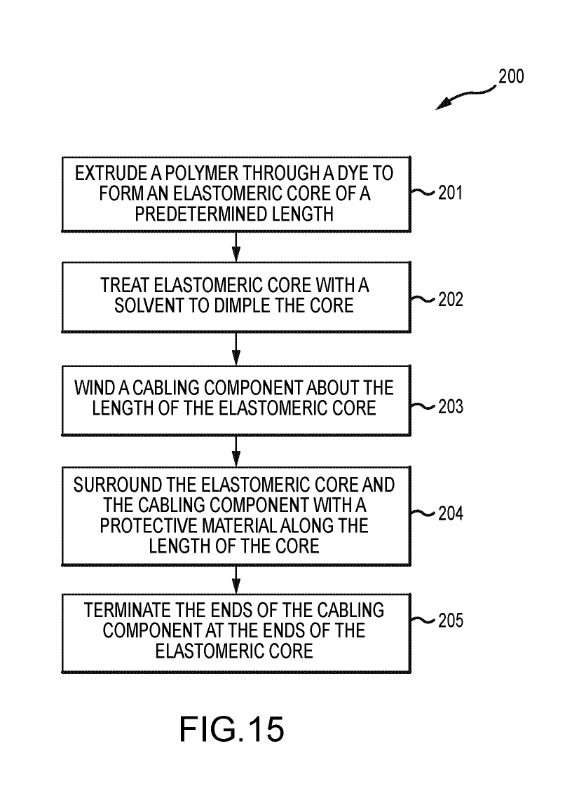

FIG. 15 is a flowchart of a method 200 for making an elastomeric cable 100. In this embodiment, a polymer is extruded through a die to form an elastomeric core 102 of a predetermined length, in the process element 201. For example, the elastomeric core 102 may be extruded through the die and then cut as desired to form certain cable lengths. After the elastomeric core 102 is extruded, the elastomeric core 102 may be treated with a solvent to dimple the core 102, in the process element 202. For example, the polymer of the elastomeric core 102 may be susceptible to deformation by certain solvents. That is, certain solvents may change the tacticity of at least the surface of the polymer. In one particular embodiment, a deformation may include dimpling of the core 102. This dimpling may allow the conductors 101 described hereinabove to more easily slide along the length of the cable 100 as the cable 100 is bent or stretched, providing more flexibility to the cable 100.

Once the elastomeric core 102 is extruded, one or more cabling components 101 are wound about the length of the elastomeric core 102, in the process element 203, as described hereinabove. That is, the cabling component 101 may comprise a ribbon conductor, one or more twisted-pair conductors, one or more optical fibers, etc. Then, the elastomeric core 102 and the cabling components 101 are surrounded with a protective material long the length of the core 102, in the process element 204. For example, a material such as a heat shrink material may be applied on top of the cabling components 101 and the elastomeric core 102. Alternatively, the elastomeric core 102 and the cabling components may be extruded through another material to protect the underlying components of the cable 100. Thereafter, the ends of the cabling components 101 are terminated at the ends of the elastomeric core 102, in the process element 205.

It should be noted that the elastomeric core 102 may be extruded in various sizes and shapes as a matter of design choice. For example, the embodiments shown and described herein illustrate elastomeric cores 102 with circular cross-sections. However, other embodiments may provide for elliptical cross-sections as a matter of design choice, as described hereinabove. Accordingly, the invention is not intended to be limited to any particular shape or size of the elastomeric core 102 or the overall cable 100.

Exemplary design configurations and methods of manufacture are shown and described in the following drawings. It should be noted however that the figures and the description herein illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention and are to be construed as being without limitation to such specifically recited examples and conditions. As a result, the invention is not limited to the specific embodiments or examples described below.

Moreover, the various embodiments shown and described herein may be combined in a variety ways as a matter of design choice. For example, a flexible optical fiber 110 (FIG. 2) may be wound alongside an electrical conductor 101 (FIG. 1) about the elastomeric core 102 to provide the overall cable with electrical and optical features.

As mentioned, the embodiments herein may be configured with a braided shielding. In some instances, the braided shielding is a braided tinned copper shielding that provides a first layer of shielding for the cable 100. Alternatively or additional, a shielding may be configured from a “paper” embedded with nickel fibers that provides shielding for the cable 100. The metallic properties of the nickel embedded in the paper can improve the overall shielding capabilities of the cable 100. Yet, the overall weight of the cable increases negligibly as the paper shielding weighs substantially less than the braided metal shielding. The paper may be implemented in a number of ways as a matter of design choice. For example, the paper may be applied underneath the braided shielding, above the braided shielding, and/or consist of multiple layers. Accordingly, the invention is not intended to be limited to the illustration herein.

What is claimed is:

1. An elastomeric cable, comprising:
an elastomeric core; and
at least one cabling component wound along a length of the elastomeric core.

2. The elastomeric cable of claim 1, wherein:
the at least one cabling component comprises an optical fiber operable to transmit data.

3. The elastomeric cable of claim 1, wherein:
the at least one cabling component comprises a metal conductor operable to transmit data.

4. The elastomeric cable of claim 1, wherein:
the at least one cabling component comprises a metal conductor operable to conduct power.

5. The elastomeric cable of claim 1, further comprising:
a protective cover surrounding the elastomeric cable along the length of the elastomeric cable.

6. The elastomeric cable of claim 5, wherein:
the protective cover comprises wings that provide a surface for sewing the elastomeric cable into fabric.

7. The elastomeric cable of claim 1, wherein:
the at least one cabling component is braided with Kevlar over the length of the elastomeric core.

8. The elastomeric cable of claim 1, wherein:
the elastomeric core is a polymer.

9. The elastomeric cable of claim 11, wherein:
the polymer is treated with a solvent to dimple the elastomeric core.

10. The elastomeric cable of claim 1, wherein:
the at least one cabling component is an Ethernet cable wound about the length of the elastomeric core.

11. The elastomeric cable of claim 1, further comprising:
a first shielding wrapped about the elastomeric core and the at least one cabling component along the length of the elastomeric cable.

12. The elastomeric cable of claim 11, further comprising:
a second shielding wrapped about the first shielding in an opposite direction.

13. The elastomeric cable of claim 12, wherein:
the first shielding, the second shielding, or both are configured from a paper embedded with nickel.

14. The elastomeric cable of claim 12, wherein:
the first shielding, the second shielding, or both comprise nickel plated aramid, cellulose, carbon fiber, or a combination thereof.

15. A method of making an elastomeric cable, the method comprising:
extruding a polymer through a dye to form an elastomeric core;
winding a cable component along a length of the elastomeric core to form an elastomeric cable; and
terminating ends of the cable with connectors.

16. The method of claim 15, further comprising:
surrounding the elastomeric cable with a protective cover along the length of the elastomeric cable.

17. The method of claim 15, further comprising:
braiding Kevlar with the at least one cabling component over the length of the elastomeric core.

18. The method of claim 15, further comprising:
treating the polymer with a solvent to dimple the elastomeric core.

19. An elastomeric cable, comprising:
an extruded polymer elastomeric core, wherein the elastomeric core comprises dimples along a length of the elastomeric core;
at least two cabling components braided with Kevlar strands along a length of the elastomeric core; and
a protective cover surrounding the elastomeric cable along the length of the elastomeric cable,
wherein the protective cover comprises wings that provide a surface for sewing the elastomeric cable into fabric.

20. The elastomeric cable of claim 19, wherein:
the at least one of the at least two cabling components comprises an optical fiber or a metal conductor.
